(19) United States
(12) Patent Application Publication
(10) Pub. No.: US 2005/0165629 A1
(43) Pub. Date: Jul. 28, 2005

(54) Systems and methods for planning the delivery of goods

(76) Inventor: Arno D. Bruns, Karlsruhe (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/765,089

(22) Filed: Jan. 28, 2004

(51) Int. Cl. G06F 17/60

(52) U.S. Cl. 705/6

(57) ABSTRACT

Systems and methods are disclosed for planning a delivery of goods. In one embodiment, a description of at least one good, a destination location, and a requested delivery date is received. Thereafter, a source location for the good is selected and a set of trips based on a set of geographic routes, transportation service provider information, and scheduling information is determined. A trip from the set of trips is selected based on a set of criteria and a scheduling the trip is performed such that the good is scheduled to be delivered from the source location to the destination location substantially close to the requested delivery date.

### BACKGROUND OF THE INVENTION

I. Field of the Invention

The present invention relates to systems and methods for planning the delivery of goods. More particularly, the present invention relates to systems and methods for determining the route for delivering a requested good from a source location to a destination location based on one or more factors, such as scheduling information.

II. Background Information

Within the logistics process of a customer ordering goods from a supplier, one of the key success factors for the supplier is planning the delivery of the goods. Typically, an order requesting, for example, a part or other goods is received by a supplier. The supplier then determines a route from the source location of the requested part or good, such as a warehouse, to the destination location, such as the customer's location. The term “route” refers to a geographical description of the flow of a good, such as the requested part, from a starting point (or source location) to an end point (or destination location). For example, a route may be represented as New York to Miami via Atlanta.

In the past, systems typically stored routes between a source location and a destination location for planning deliveries. When there was a need to delivery the requested part or other goods between source and destination, the supplier would schedule a trip based merely on the stored route information. The term “trip” means a specific instance of a route. Returning to the previous example of a route from New York to Miami, a trip may further define a specific date, time, carrier, and/or vehicle, e.g., October 30, 0900 hours, via Carrier X, and Truck Y. The term “carrier” means an entity or object that transports or conveys.

Typically, requested goods have an associated timeline or schedule. For example, a part requested by a customer may have a material availability date (MAD) that represents when the part is available at the source, such as a warehouse. The part may also have a load date representing the time when the part is loaded, e.g., boxed in a shipping container and/or loaded on a pallet ready for loading on a vehicle. The part may also have a goods issue date representing when the part may be on a loading dock ready for pick-up by a carrier. The part may also have an associated transport time representing the duration of the trip from the source to the destination. Lastly, the part may have a requested delivery date representing when the customer has requested the product, and an actual delivery date representing when the part was actually delivered to its destination. All of these dates form a timeline representing a schedule for the requested part.

If a part is available from different sources, each warehouse may have a different timeline. For example, a warehouse may be closer to the destination or have a MAD that is sooner than another warehouse. However, with past approaches, the route was determined independently of the overall schedule associated with the requested part. Because the route and schedule were determined independently, changes in the schedule did not effect the determination of the route. For example, the route of New York to Miami via Atlanta would always be used from a particular source to a particular destination, not taking into account any scheduling differences that may permit a different or better route in terms of cost or schedule. Moreover, if a customer requested a part or other goods, and then later requested a different time for delivery (e.g., sooner), past systems were not able to flexibly determine a new route.

There are other factors, such as cost and environmental concerns that vary when the route is changed. For example, some routes may take a longer amount of time but cost less in terms of dollars per mile. Some carriers may not transport hazardous cargo. As such, past systems that did not integrate scheduling and route determination were not able to flexibly account for such factors.

In view of the foregoing, there is a need for improved systems and methods for route planning and determination. For example, there is a need for systems and methods that integrate route determination with scheduling. There is also a need for route planning systems and methods that include the ability to handle a broad variety of restrictions including, for instance, restrictions relating to the geographic route, the schedules, and/or carriers associated with transporting goods requested by the customer.

### SUMMARY OF THE INVENTION

Consistent with embodiments of the present invention, systems and methods are disclosed for planning the delivery of a requested good, including scheduling the route that the good will travel from a source location to a destination location.

In one embodiment, consistent with the present invention, systems and methods are provided for planning a delivery of at least one good. Moreover, systems and methods are provided for receiving a description of the good, a destination location, and a requested delivery date, and for selecting a source location for the good. Furthermore, systems and methods are provided for determining a set of trips based on a set of geographic routes, transportation service provider information, and scheduling information. In addition, systems and methods are provided for selecting a trip from the set of trips based on a set of criteria, and then scheduling the trip such that the good is scheduled to be delivered from the source location to the destination location substantially close to the requested delivery date.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 depicts an exemplary system environment, in accordance with systems and methods consistent with the present invention;

FIG. 2 depicts a block diagram of another exemplary system environment, in accordance with systems and methods consistent with the present invention;

FIG. 3 depicts a block diagram of an exemplary planner module for determining schedules and routes, in accordance with systems and methods consistent with the present invention;

FIG. 4 depicts a flowchart with exemplary steps for planning a delivery of goods, in accordance with systems and methods consistent with the present invention;

FIG. 5 depicts another flowchart with exemplary steps for planning a delivery of goods, in accordance with systems and methods consistent with the present invention;

FIG. 6 depicts an exemplary schedule, in accordance with systems and methods consistent with the present invention; and

FIG. 7 depicts another flowchart with exemplary steps for planning a delivery of goods, in accordance with systems and methods consistent with the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations, and other implementations are possible, without departing from the spirit and scope of the invention. For example, substitutions, additions, or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

Systems and methods are disclosed for scheduling a customer order involving the transportation of goods. The scheduling systems and methods take into account route information, scheduling information, and transportation service provider (or carrier) information to determine one or more trips for the delivery of the goods. The scheduling systems and methods may also consider additional restrictions, such as dangerous goods laws and/or other criteria to select one of the trips to transport the requested goods. The term “goods”, as used herein, refers to any quantity or number of goods. Goods may comprise, for example, any quantity or number of parts, products, materials, merchandise, supplies or any other item to be delivered.

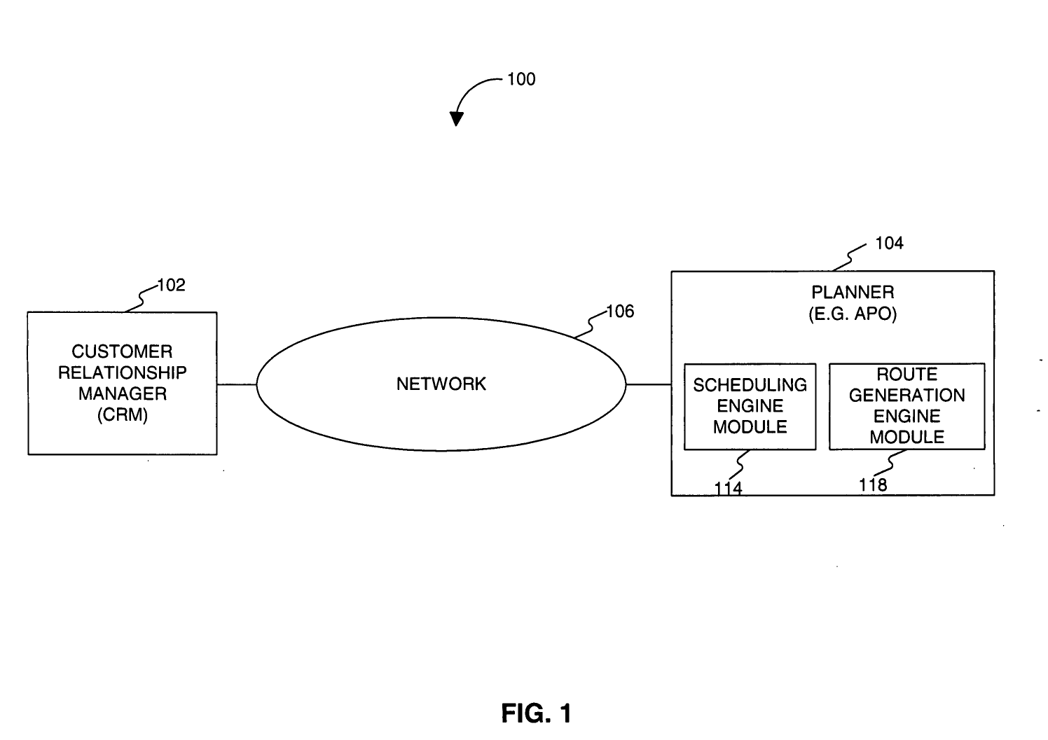

FIG. 1 depicts an exemplary system 100, in accordance with systems and methods consistent with the present invention. As shown in FIG. 1, the system 100 may include a Customer Relation Management (CRM) module 102, a network 106, and a planner module 104.

The CRM 102 may be embodied as a data processor, such as a computer, that supports all processes involving customer contact. In one embodiment, CRM 102 may be implemented as part of a customer relationship management system, such as the mySAp™ CRM system available from SAP AG (Walldorf, Germany). CRM 102 functions to receive orders and to send order information to planner 104 through network 106. Orders processed by CRM 102 may comprise, for example, customer orders including sales orders. A sales order, as used herein, represents any type of request for goods (e.g., any number or quantity of product(s), part(s), material(s), etc.).

Although CRM 102 may be implemented as a single computer, CRM 102 may also consists of a plurality of computers connected by network 106. For example, in a system environment with a plurality of customers, each of the customers may be provided with a computer providing access to some or all of the functions related to CRM 102. For example, the plurality of customers may be technicians at various locations, with the technicians requesting parts or other goods. Alternatively, the customers may be retailers selling sweaters at a local retail outlet, with each sale representing a request for another product to be stocked on the retailer's shelf.

Network 106 may be embodied as any type of communication medium or channel and may include, alone or in any suitable combination, a telephony-based network, a local area network (LAN), a wide area network (WAN), a dedicated intranet, the Internet, a wireless network, or a bus. Moreover, in one embodiment, network 106 may include or be a part of a communications network, such as the Internet or a corporate intranet that is compatible with a networking protocol such as TCP/IP (Transport Control ProtocolInternet Protocol).

Planner module 104 may be embodied as a data processor, such as a computer, that functions to receive sales order information from CRM 102 and perform planning processes, such as planning the delivery of goods. As shown in FIG. 1, planner 104 may include a scheduling engine module 114 for scheduling the order and returning scheduled order information to CRM 102 and/or other systems. As used herein, the term “scheduling” means to determine one or more dates associated with the planned delivery of a good, such as a sales order requesting parts or other goods. For example, scheduling may include determining pick-up and delivery dates for the requested part. Planner 104 may further include a route generation engine module 118 for determining one or more routes (also referred to herein as geographic routes) that satisfy a schedule determined by schedule engine 114.

While planner 104 is illustrated in FIG. 1 as including a scheduling engine 114 and a route generation engine module 118, planner 104 may be configured in other ways. Further, planner 104 may be implemented as a module of a computerized system. For example, in one embodiment, planner 104 is implemented as part of a planning system, such as the Advanced Planning and Optimization (APO) system available from SAP AG.

Referring again to FIG. 1, CRM 102 may receive an order or request for goods from a customer. The order may include one or more of the following: an identity of the source of the request (e.g., the customer); a destination location for the requested goods; a requested delivery date; and/or any other information associated with the delivery of the sales order (or requested goods). Planner 104 then determines whether there is a source location for the requested goods (e.g., a warehouse or manufacture) that has it in stock and available for shipment. If so, planner 104 selects that source location for further planning. If there is more than one source, planner 104 may select a default location as the source or use some other type of rule (e.g., cost or distance to destination) to pick the source location for further planning.

Planner 104 then proceeds to determine one or more trips for the selected source. To determine trips, planner 104 may use the requested delivery date provided by the customer as the initial starting point for scheduling, and then work backward, i.e., scheduling trips based on the requested delivery date. Alternatively, planner 104 may use a material availability date (MAD) at the source location as the initial starting point for scheduling, and then schedule forward, i.e., scheduling trips based on the MAD. In either case, planner 104 may call route generation engine 118 to determine a set of routes from the source location to the destination location. Route generation engine 118 may further determine transportation service provider information, such as the identity of a carrier, a type of vehicle used to transport the requested goods, a means of transport (e.g., truck, train, plane, ship, etc.), a cost, and any other information associated with the carrier. Route generation engine 118 may also determine arrival and departure information from the source location to the destination location for any identified carriers. Based on the schedule information, transportation service provider information, and routes, planner 104 determines one or more trips from the source to the destination.

Planner 104 then selects one of the trips based on a set of criteria. The set of criteria may include factors to evaluate the trips, such as cost per mile, closeness to delivery date, refrigeration, and/or speed of delivery. For example, with a perishable good, such as fresh flowers, speed of delivery and refrigeration may weigh more heavily in selecting a trip than the cost per mile.

Once a trip is selected, planner 114 further schedules the trip by constructing a timeline from the source location to the destination location, assigning dates to the trip, assigning the goods associated with the sales order, confirming dates with the carrier(s), confirming dates with the source (e.g., the warehouse), confirming dates with the destination, and/or confirming dates with any other entity associated with the transport of the requested goods. If the source location or carrier cannot confirm the schedule, planner 104 may identify another source for the requested goods, another route, another trip, and/or another carrier. As such, planner 104 may more flexibly change the route when scheduling the delivery of the goods. Moreover, planner 104 may provide CRM 102 with schedule information, such as the delivery date and any other information associated with the scheduled trip, such that CRM 102 can update the customer's original request or order. The customer requesting the goods can thus view updated status information for the requested goods.

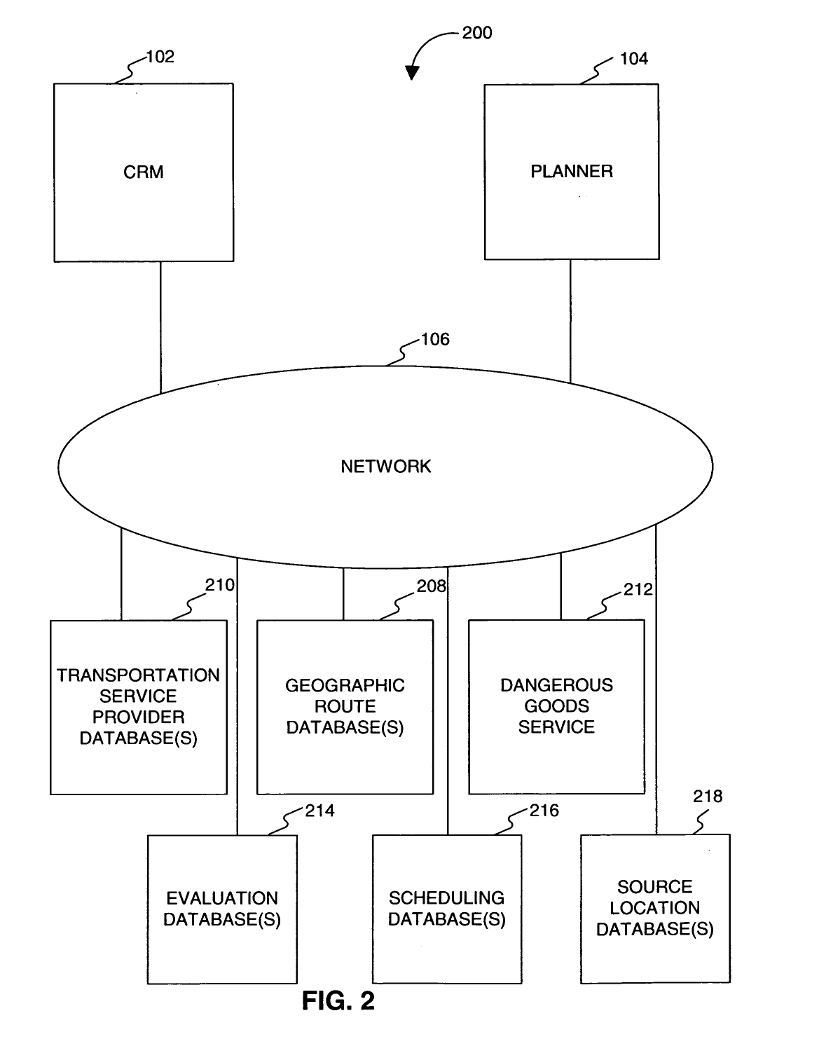

FIG. 2 depicts another exemplary system 200, in accordance with systems and methods consistent with the present invention. The system 200 includes CRM 102, network 106, and planner 104, which may be implemented as described above. System 200 further includes, however, a source location database 218, a scheduling database 216, an evaluation database 214, a dangerous goods database 212, a geographic route database 208, and a transportation service provider database 210. Although each of databases 208-218 is depicted as a single database, each may be embodied as a plurality of databases or may be combined with one other. Further, each of the databases 208-218 may store information that can be accessed through a conventional database protocol, such as Structured Query Language (SQL). Although not depicted in FIG. 2, one of ordinary skill in the art will recognize that databases 208-218 may include a computer or data processor for accessing, searching, and/or processing stored information. Furthermore, although databases 208-218 are depicted as being separate, one of ordinary skill in the art will recognize that databases 208-218 may be implemented through a single database.

Source location database 218 may include information for determining a source location capable of fulfilling the order received through CRM 102. For example, database 218 may identify parts or other goods that are available at one or more source locations, e.g., facilities, warehouses, or manufacturers. Moreover, as shown in FIG. 2, source location database 218 may be accessed by planner 104 through network 106.

Transportation service provider database 210, geographic route database 208, and scheduling database 216 are databases accessed by planner 104 through network 106. Collectively, these databases may function to provide information used to determine a set of trips. As noted above, a trip refers to a specific instance of the route and may include a description of the route, scheduling information associated with the route, and transportation service provider information associated with a route (e.g., NY to Cleveland, Aug. 7, 2003, 9 AM, Carrier X, truck number B).

Evaluation database 214 is a database that stores criteria used by planner 104 to evaluate or score each trip, as further described below. Dangerous goods database 212 is a database accessed by scheduler 104 through network 106 for checking the set of potential trips for compliance with dangerous goods laws. Dangerous goods database 212 may include a computer for performing dangerous goods checks that filter inappropriate trips. As part of this service, dangerous goods database 212 may store information or records of dangerous substances, goods, rules, regulations, and/or agents.

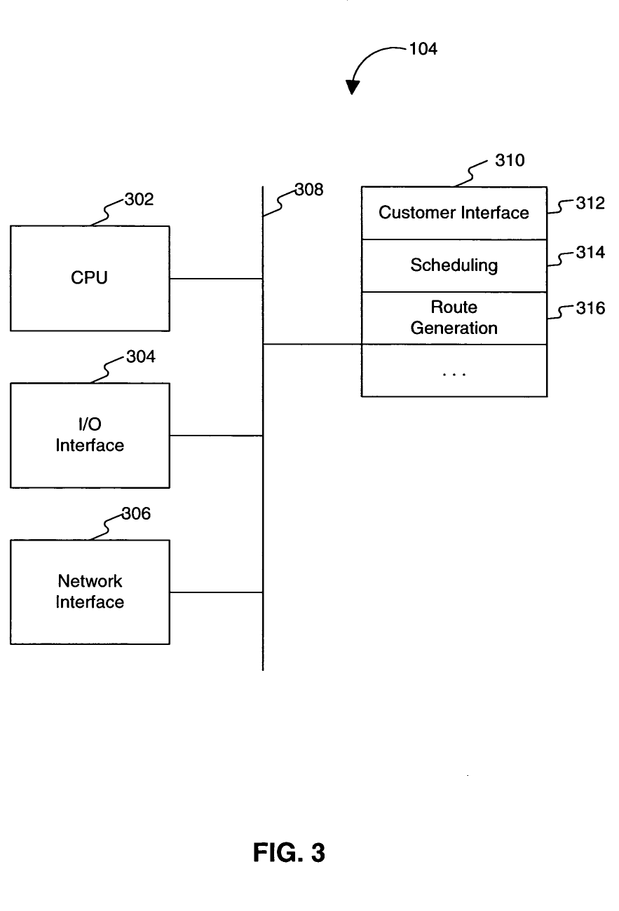

FIG. 3 is a block diagram of an exemplary embodiment of planner 104. As shown in FIG. 3, planner 104 may be implemented as a data processor or computer and include a central processing unit (CPU) 302, an I/O (input/output) interface 304, a network interface 306, and a memory 310. CPU 302 executes instructions associated with the processes contained in memory 310 and transmits results to other subsystems in planner 104 over a high speed interconnect or data bus 308. I/O interface 304 is an interface used to couple planner 104 with devices such as a keyboard, a mouse, a display device and/or other I/O devices (not shown) useful in operating and managing planner 104. The network interface 306 may be used to communicate through network 106 to other computers or processors therein.

Memory 310 includes, in one embodiment, a customer interface process 312 having program instructions that when executed receive sales order information for goods from CRM 102, select a source location, and return the confirmed schedule to CRM 102. Memory 310 may also include a scheduling process 314 having program instructions that when executed schedule the order and a route generation process 316 having program instructions that when executed determine trips for the order.

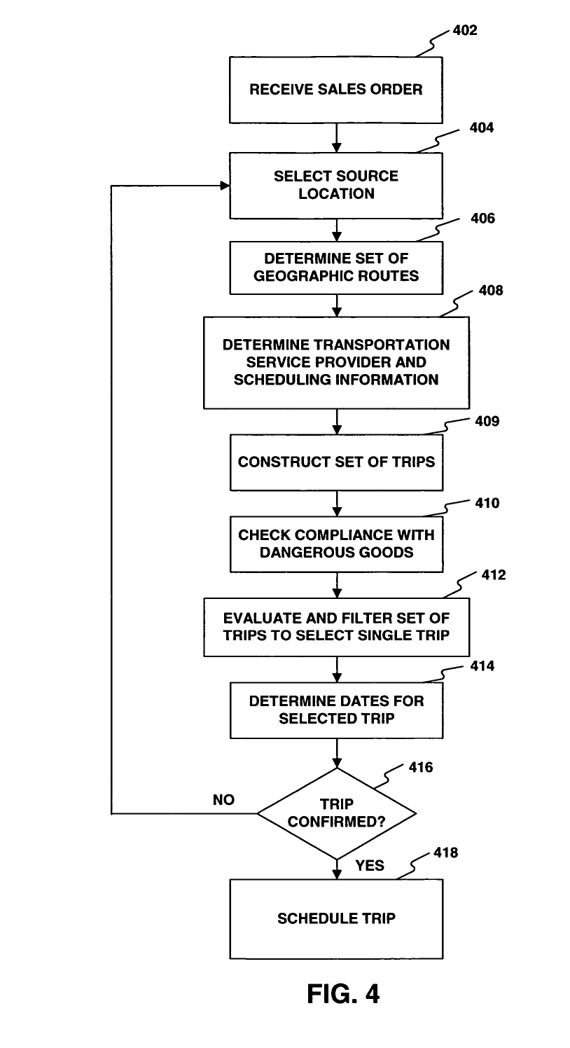

Referring to FIG. 4, there is shown a flow diagram with exemplary steps for planning the delivery of goods, consistent with the present invention. The flow diagram will be described with reference to the embodiment of system 200 depicted in FIG. 2 and planner 104 depicted in FIG. 3. However, as will be appreciated by those skilled in the art, the embodiment of FIG. 4 may be implemented in other systems environments, such as that depicted in FIG. 1.

Initially, planner 104 receives the sales order information from CRM 102 (step 402). A sales order from, for example, a customer, can include one or more line items, each line item representing a separate request for goods or a service. For example, the sales order may represent the sale of a good, a parts order, a service, a material, or any other request. Each line item may include an identity of the requested goods, the quantity, and the requested delivery date. In addition, the sales order may include the destination location for the order, i.e., where to deliver the good. CRM 102 can separately send information corresponding to each line item of the sales order, or CRM 102 can send information corresponding to the entire sales order including the plurality of line items. The customer interface process 312, executed by CPU 302, receives the information corresponding to the sales order or line item.

After receiving the sales order, the customer interface process 312 selects a source location capable of fulfilling the sales order or line item therein (step 404). In one embodiment, customer interface process 312 may select a source location where the requested goods are available to fulfill the sales order from source location database 218. Customer interface process 312 may select a default location contained in database 218 when there are multiple source locations capable of fulfilling the sales order (or the line item). The source location refers to any location such as a facility, warehouse, or manufacturer where the requested goods are or can be made available to fulfill the customer's request. Source location database 218 returns to customer interface process 312, the source location and, if available, the MAD (material availability date), i.e., the date the source location can make the requested goods available for packing, loading, and/or shipping. For example, from the time the order is placed, a given source location may require two weeks before the requested good can be made available for shipping. Thus, the MAD for that source location would be a date two weeks after the date the order is placed at the source location. When the MAD is not available, planner 104 may estimate a MAD and then confirm the MAD at step 416, as described below. Alternatively, interface process 312 may first select a default source location, schedule backward from the requested delivery date (by, e.g., calling route generation 316 to determine a trip duration), and calculate a required MAD. The source location is then checked to verify whether it can meet the calculated MAD. If so, the source location and MAD are confirmed. Otherwise, interface process 312 attempts to confirm a later MAD and then schedule forward (with route generation 316) to determine a new delivery date. If that date is acceptable (per the original sales order), then the source location and new delivery date can be used. Otherwise, another source location may be selected that can satisfy the MAD and requested delivery date.

After determining the source location, customer interface process 312 calls scheduling process 314, which schedules the order. Scheduling process 314 first calls route generation process 316 to determine routes and specific instances of routes (or trips) that satisfy the schedule associated with the order. Scheduling process 314 then sends the source location, the destination location, and the requested delivery date to route generation process 316.

Route generation process 316 may first determine a set of geographic routes for transporting the requested goods from the source location to the destination location (step 406). In such a case, route generation process 316 may search through geographic route database 208, which contains geographic route information. Geographic route information may include geographic descriptions of the flow of goods from a starting point to an end point. A geographic description may further include a number of stops between the starting point and the end point. For example, if the source location is in Washington, DC and the destination location is in Boston, the geographic route information may consist of two geographic routes. The first route may start in Washington, DC, stop in Philadelphia, and then end in Boston. The second route may start in Washington, stop in New York City, and then end in Boston. The geographic route information may also include the means of transportation for the flow of goods. For example, regarding the first route, the means of transportation from Washington, DC to Philadelphia may be by truck, while the means of transportation from Philadelphia to Boston may be by airplane. Furthermore, the geographic route information may include information regarding the identity of the carrier (e.g., if it is unique), as well as the number of vehicles and the size of the vehicle that will be used to transport the materials (or just the means of transportation). A vehicle refers to any means of transporting the goods, such as a truck, airplane, train, or ship. Although geographic route database 208 is described above in terms of a database, geographic route database 208 may include a data processor or computer, such as a route generation engine (see, e.g., route engine 118 in FIG. 1).

Route generation process 316 may create restrictions for the various routes that are selected from the geographic route database 208. For example, the source location and the destination location can be categorized by country, subcategorized by region, and further subcategorized by zone. The various routes can be restricted such that they stop only in selected zones, regions, or countries. For example, for a source location and a destination location in the same country, it may be desirable to select geographic routes that only stop in that country, avoiding unnecessary border and customs checks.

After route generation process 316 has determined a set of geographic routes, route generation process 316 determines the scheduling information and the transportation service provider information corresponding to each geographic route (step 408). In some embodiments, route generation process 316 first checks scheduling database 216 to determine the scheduling information associated with each geographic route. Route generation process 316 then checks the transportation service provider database 210 to determine the transportation service provider information corresponding to each geographic route and its associated scheduling information. In other embodiments, route generation process 316 first checks transportation service provider database 210 to determine the transportation service provider information corresponding to each geographic route. Then, route generation process 316 gathers the scheduling information associated with the transportation service provider information from scheduling database 216. For example, there may be several trucking carriers that can transport a requested item from Philadelphia to Boston. Furthermore, each trucking company may have various schedules with several departure dates and times for transporting the requested goods.

Next, route generation process 316 constructs a set of potential trips based on the geographic route information, the scheduling information, and the transportation service provider information (step 409). Each trip includes a route (e.g., geographic route information), scheduling information (e.g., a pick-up time and a delivery time), and transportation service provider information (e.g., carrier, means of transport, etc.).

Route generation process 316 may then check the set of trips against restrictions representing, for example, dangerous goods laws (step 410). In one embodiment, this step is performed only if the trip or the description of the goods to be transported includes a flag indicating that compliance should be checked. Route generation process 316 may call dangerous goods database 212 to filter the set of trips for restrictions from dangerous goods laws. Dangerous goods database 212 receives the description of the goods to be transported and the trip information including, in one embodiment, the countries that are passed through, the means of transportation, and the transportation service provider information. Based on this information, dangerous goods database 212 eliminates any trips that do not comply with dangerous goods laws and returns any remaining feasible trips. For example, it may be illegal to ship certain hazardous materials by air. When that is the case, dangerous goods database 212 will eliminate the trips in which those hazardous materials are shipped by air.

After determining the set of feasible trips, route generation process 316 evaluates and filters the set of trips to select a single trip (step 412). In one embodiment, route generation process 316 evaluates each trip according to a set of criteria, assigning a score value to each trip based on the evaluation. Route generation process 316 evaluates each trip using information in evaluation database 214. For example, cost may be an evaluation criterion. Route generation process 316 may receive cost information for each trip from evaluation database 214. The cost information may be related to the distance of the trip, the transportation service provider associated with the trip, or the weight of the goods being shipped. Route generation process 316 may then assign the highest priority (or score) to a trip having the lowest cost. Similarly, earliness or lateness of delivery with respect to the requested delivery date can be an evaluation criterion. Route generation process 316 can prioritize or score each trip based on how early or late delivery of the requested item will be with respect to the requested delivery date. Evaluation database 214 can also provide specific information regarding each customer in order to assign a priority or score based on the time of delivery. For example, one customer may not be able to accept delivery after the requested delivery date, or another customer may incur a severe financial penalty for delivery in advance of the requested delivery date. Moreover, the set of evaluation criteria may also be embodied as a combination of the above examples. For example, the priority or score can be a combination of cost information, on-time information, and customer specific information.

Based on the results of the evaluation process, route generation process 316 selects a single trip (step 412). In one embodiment, route generation process 316 selects the trip having the lowest cost that results in delivery on or substantially close to the requested delivery date. In another embodiment, to select the most appropriate trip, route generation process 316 may use optimization algorithms, which are known and commercially available such as the generalized assignment with multiple dimension algorithms included in the Transportation Planning/Vehicle Scheduling (TPNS) module available from SAP AG.

Consistent with the present invention, route determination process 316 can select the trip based on a given departure date. For example, the customer may want the goods to ship as early as possible, or the source location can only make the goods available on a certain date. In such cases, route generation process 316 receives from scheduling process 214 the given departure date (e.g., the MAD) and then schedules forward from that date by eliminating any trips that that do not depart on the given departure date. The remaining trips are selected based on the evaluation process described above with respect to steps 410-418.

Scheduling process 314 receives the trip information from route generation process 316 and further determines the delivery schedule associated with the requested good (step 414). The trip information includes dates and times associates with the trip, such as a departure (or pick-up) time for the requested goods to be shipped from the source location. Scheduling process 314 may further determine other dates associated with the scheduled delivery, such as the transportation planning date, goods issue date, load date, and, if necessary, the MAD. For example, if the goods are to be picked up on August 15 and the source location requires 14 days to make the goods available for shipping (i.e. the source location lead time is 14 days), the scheduling process 314 may estimate August 1 as the MAD. Alternatively, the MAD may be stored in source location database 218, permitting scheduling process 214 to simply look-up the MAD. Scheduling process 314 may later confirm the MAD (or the estimated MAD) with the source location during step 414. In one embodiment, a gATP module, described below, confirms that the source location can meet the MAD.

Scheduling process 314 returns to customer interface process 312 one or more of the following: a schedule for shipping the requested goods including a MAD at the source location; a good issue date indicating when the good can be issued to (or picked-up by) the carrier for shipment; and a delivery date at the destination. Customer interface process 312 confirms the schedule (step 416). The schedule is confirmed, in an embodiment, if the source location can provide the requested goods by the MAD and if the carrier's delivery date is substantially close to the requested delivery date of the customer. Of course, whether the delivery date is substantially close to the requested delivery date can be defined for each customer and stored in evaluation database 214. For example, one customer may demand delivery within two days of the requested delivery date, while another may demand delivery within two weeks of the requested delivery date. If confirmed, customer interface process 312 schedules the order and returns the scheduling information to CRM 102, so that the customer can view the updated information (step 418).

In an alternative embodiment, planner 104 processes, using steps 404-416, all of the source locations with the requested good available and then picks the source location with the best score (e.g., based on the criteria of step 412).

If customer interface process 312 cannot confirm the trip because the source location cannot provide the goods by the MAD, in one embodiment, customer interface process 312 may call scheduling process 314 to select another trip based on the earliest possible date that the source location can make the requested goods available for shipping. Route determination process 316 may then eliminate any trips that do not depart on this date, as described above. Alternatively, customer interface process 312 can select a different source location that can meet the MAD, and then schedule the order using the different source location and the MAD, thus repeating steps 404-418. Similarly, if customer interface process 312 cannot confirm the schedule because the delivery date is not substantially close to the requested delivery date, customer interface process 312 can select a different source location and reschedule the order.

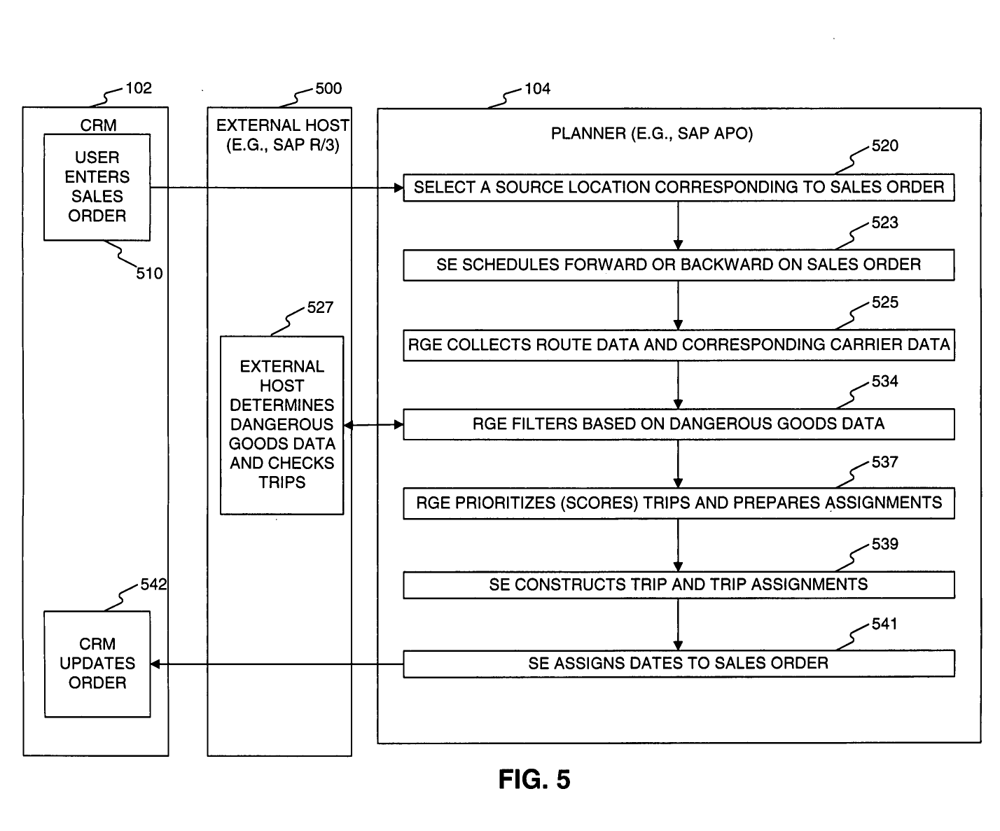

FIG. 5 depicts another flowchart with exemplary steps for planning a delivery of goods, in accordance with systems and methods consistent with the present invention. Referring to FIG. 5, CRM 102 provides sales order information to planner 104, which receives the sales order (step 510). As noted above, the sales order may include one or more line items, each line including, for example, a set of goods requested by the customer. Planner 104 then selects a source location that has the requested goods available (step 520). In one embodiment, the sales order includes a relevancy flag, allowing planner 104 to skip steps 523-539. However, the following description of FIG. 5 assumes that the relevancy flag indicates that a complete planning process should be performed including steps 523-539. In one embodiment, Planner 104 includes an integrated Global Available-to-Promise (gATP) module, which is commercially available from SAP AG, for selecting a source location with the requested goods available. Moreover, the gATP module may be used to call the scheduling engine 114 and route generation engine 118.

Scheduling engine 114 (labeled as “SE” on FIG. 5) may then schedule forward or backward based on information included in the sales order (step 523). Specifically, the sales order may include information indicating that the goods must be delivered by a requested delivery date—thus indicating that backward scheduling is appropriate. Alternatively, the sales order may include information indicating that the goods must be delivered as soon as it is available (e.g., a rush order)—thus indicating that forward scheduling may be appropriate. In the backward scheduling case, scheduling engine 114 may build a schedule or timeline working back from the requested delivery date. In the forward scheduling case, scheduling engine 114 may build the timeline working forward from the MAD of a source location of the requested good.

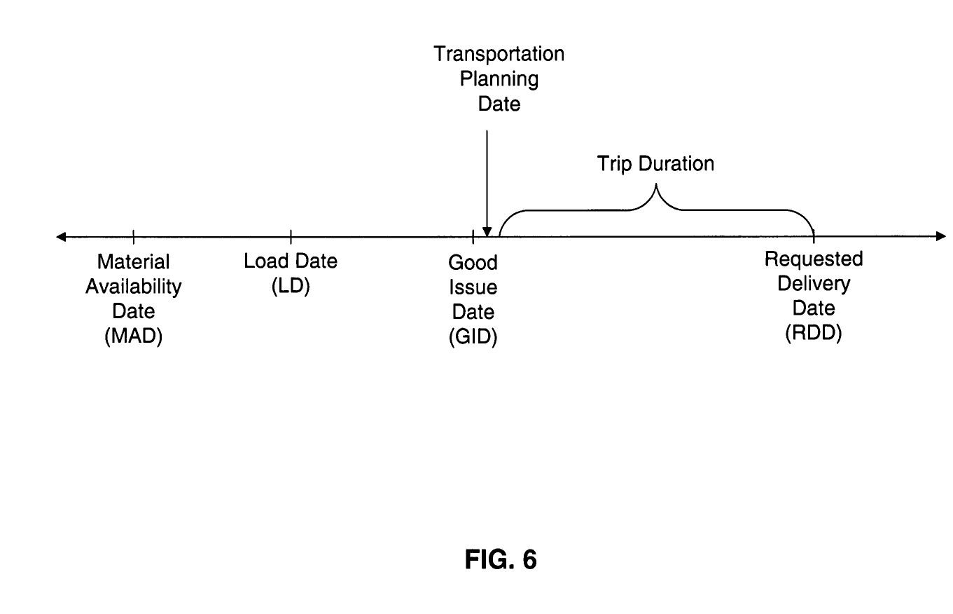

For purposes of illustration, FIG. 6 depicts an exemplary timeline that includes the requested delivery date (RDD). When determining a schedule backward from the RDD, scheduling engine 114 works backward. First, scheduling engine 114 determines a trip duration for a trip, with the transportation planning date representing the date which the carrier must be notified in order to make the RDD. Scheduling engine 114 may further determine a goods issue date representing the date when the requested good can be provided to a carrier for shipment, a load date representing the date when the requested goods are available for loading (e.g., after packing and crating), and a MAD, which is the initial date a good is available at a warehouse or manufacturing facility. On the other hand, in the case of a forward schedule, the scheduling engine 114 essentially operates in reverse working forward from the MAD by first determining the MAD and then determining routes and trips that satisfy the MAD.

Referring again to FIG. 5, route generate engine 118 (labeled as “RGE” on FIG. 5) then collects route information and corresponding carrier or transportation provider information based on the source location, destination (e.g., a ship-to address), and any other schedule information, such as the RDD or the MAD (step 525). For example, route generation engine 118 may determine a set of trips between a source location, e.g., Washington, DC, and a destination location, e.g., New York City, that are substantially close to the requested delivery date, e.g., August 7. In one embodiment, route generation engine 118 searches databases 208, 210, and/or 216 when identifying possible trips.

With the possible trips determined, an external host 500 (such as a component of an SAP R/3 system) may be used to collect and store dangerous goods information (step 527). Route generation engine 118 may filter any trips against such dangerous goods data. For example, route generation engine 118 may flag goods that are dangerous and flag the countries (or regions) in which the goods may travel when in transport from the source to the destination locations. External host 500, which can be configured in a similar fashion to dangerous goods database 212, may then use stored dangerous goods information to identify that it may be illegal to ship certain hazardous materials, such as flammable liquids, by air or through a specific country or region. When that is the case, route generation engine 118 filters out all trips that include air as a means of transportation or travel through that prohibited region (step 534). As such, the trips that remain (if any) are trips that do not include any transportation means that utilizes air or traverse the prohibited region.

Next, planner 104 (or route generation engine 118) may prioritize the possible trips by scoring them based on a set of criteria (step 537). As noted above, the criteria may include various factors such as cost and closeness to the requested delivery date. Scheduling engine 114 may then select a trip based on its score (e.g., lowest cost per mile, trip that best meets the RDD, or soonest delivery date). The selected trip construction is completed by assigning dates to the timeline (see, e.g., FIG. 6) and scheduling the trip delivery date and pick-up date with the carrier (steps 539-541). Moreover, scheduling engine 114 may confirm with the source location, such as the warehouse that it can satisfy the assigned dates, such as the MAD, LD, and GID. In one embodiment, if the carrier or source location cannot confirm the assigned dates, steps 520-539 are performed again to determine another source, another route, and/or another trip. When the carrier and/or source location confirm that they can meet the assigned dates, scheduling engine 114 may then provide the assigned dates including the carrier information to CRM 102 to update the sales order (step 542). In one embodiment, the capacity of the carrier is also considered. For example, when transporting milk, the capacity of the carrier to transport a specified number of gallons (or liters) of milk is also confirmed. Similarly, whether a carrier can transport a partial shipment may also be considered as part of trip confirmation.

Returning to step 537 above, in one embodiment, an objective function is used to select a trip. The objective function is used to evaluate the set of trips and the corresponding routes, carriers, and schedules. For example, the objective function may be used to assign a penalty cost for late or early delivery. Specifically, the objective function is used to compute a penalty cost for a first one of the possible trips. Next, the objective function is used to compute a penalty cost of a second one of the possible trips. If the second trip has a lower penalty cost than the first trip, the second trip is the “selected” trip; otherwise, the first trip remains the “selected” trip. The objective function further processes each of the remaining possible trips to find the lowest cost trip, making that trip the “selected” trip, which is selected in step 537. One of ordinary skill in the art will recognize that the objective function may include other factors to determine a penalty cost (or score) for each trip.

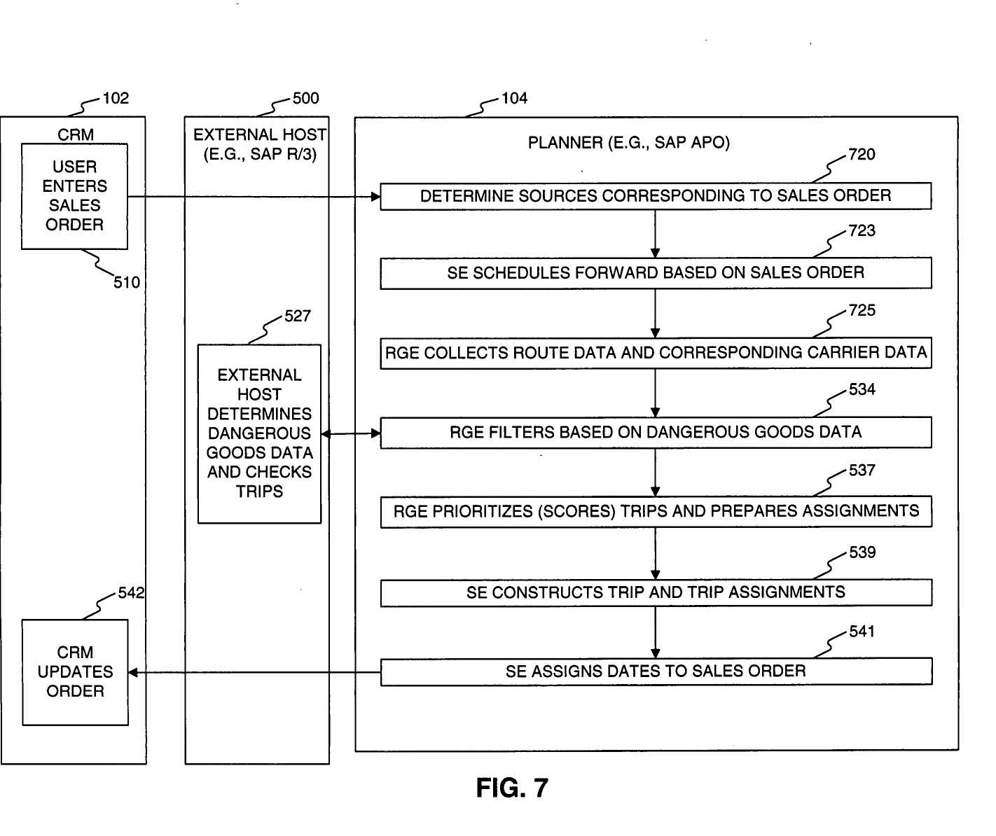

FIG. 7 depicts another diagram with exemplary steps for planning a delivery of goods, in accordance with systems and methods consistent with the present invention. FIG. 7 is similar to FIG. 5, except that it depicts the case of a rush order, e.g., deliver the requested good as soon as it is available. Since the sales order request is a rush order, planner 104 first performs a global availability check of all sources that can provide the requested good without any concern for trip duration. At this point planner 104 provides to scheduling engine 114, a list of sources locations, material availability dates, and (if applicable) quantities of goods at each source location. Planner 104 may then select a source location based on, for example, earliest MAD (step 720). Planner 104 then provides the source location to scheduling engine 114 (labeled “SE” on FIG. 7) for scheduling. Scheduling engine 114 then schedules forward using the source location, MAD, and destination location (step 723). As such, route generation engine 118 identifies routes and corresponding trips that depart on or after the MAD (step 725). The determined trips are then processed as described above with respect to steps 534-542. As such, the planner 104 is able to more flexibly schedule the delivery of a good that is requested by a customer.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

1. A method for planning a delivery of at least one good, comprising:
receiving a description of the good, a destination location, and a requested delivery date;
selecting a source location for the good;
determining a set of trips based on a set of geographic routes, transportation service provider information, and scheduling information;
selecting a trip from the set of trips based on a set of criteria; and
scheduling the trip such that the good is scheduled to be delivered from the source location to the destination location substantially close to the requested delivery date.

2. The method of claim 1, wherein determining a set of trips comprises selecting one or more geographic routes from the set of geographic routes.

3. The method of claim 2, wherein selecting one or more geographical routes comprises restricting the set of geographical routes based on a geographical classification for the source location and the destination location.

4. The method of claim 1, wherein determining a set of trips comprises selecting a transportation service provider for each geographic route.

5. The method of claim 1, wherein the set of criteria comprises at least one criterion representative of dangerous goods.

6. The method of claim 1, wherein the set of criteria comprises at least one criterion representative of closeness of a trip delivery date to the requested delivery date.

7. The method of claim 1, wherein the set of criteria comprises at least one criterion representative of cost information.

8. The method of claim 1, wherein the set of criteria comprises at least one criterion representative of customer information.

9. The method of claim 1, wherein the set of criteria comprises at least one criterion representative of a date the source location can make the good available for shipping.

10. The method of claim 1, wherein scheduling comprises confirming the source location can make the good available for shipping by a trip departure date of the trip.

11. The method of claim 10, wherein scheduling further comprises selecting, if the trip is not confirmed, another trip based on a date the source location can provide the good for shipping.

12. A system for planning the delivery at least one good, the system comprising:
a central processing unit;
a customer interface process configured for execution by the central processing unit, the customer interface process comprising instructions for receiving a description of the good, a destination location, and a requested delivery date, and for selecting a source location for the good; and
a scheduling process initiated by the customer interface process comprising instructions for:
initiating a route generation process comprising instructions for determining a set of trips based on a set of geographic routes, transportation service provider information, and scheduling information, wherein each trip comprises a trip departure date and a trip delivery date; and selecting a trip from the set of trips based on a set of criteria; and
scheduling the trip such that the requested good is scheduled to be delivered from the source location to the destination location substantially close to the requested delivery date.

13. The system of claim 12, wherein the route generation process further comprises instructions for selecting at least one geographic route from the set of geographic routes.

14. The system of claim 13, wherein the route generation process further comprises instructions for restricting the set of geographical routes based on a geographical classification for the source location and the destination location.

15. The system of claim 12, wherein the route generation process further comprises instructions for selecting transportation service provider information and scheduling information corresponding to the set of geographic routes.

16. The system of claim 12, wherein the route generation process further comprises instructions for checking the set of trips for compliance with the set of criteria, the set of criteria including at least one criterion representative of dangerous goods.

17. The system of claim 12, wherein the set of criteria comprises at least one criterion representative of closeness of the trip delivery date to the delivery date

18. The system of claim 12, wherein the set of criteria comprises at least one criterion representative of cost information.

19. The system of claim 12, wherein the set of criteria comprises at least one criterion representative of customer information.

20. The system of claim 12, wherein the set of criteria comprises at least one criterion representative of a date the source location can make the good available for shipping.

21. The system of claim 12, wherein the customer interface process further comprises instructions for confirming whether the source location can make the good available for shipping by the trip departure date of the trip.

22. The system of claim 21, wherein the customer interface process further comprises instructions for initiating, if the trip is not confirmed, the scheduling process to select another trip based on a date the source location can make the good available for shipping.

23. A computer-readable medium containing instructions to configure a data processor to perform a method for planning a delivery of at least one good, the method comprising:
receiving a description of the good, a destination location, and a requested delivery date;
selecting a source location for the good;
determining a set of trips based on a set of geographic routes, transportation service provider information, and scheduling information;
selecting a trip from the set of trips based on a set of criteria; and
scheduling the trip such that the good is scheduled to be delivered from the source location to the destination location substantially close to the requested delivery date.

24. A system comprising:
means for receiving a description of at least one good, a destination location, and a requested delivery date;
means for selecting a source location for the good;
means for determining a set of trips based on a set of geographic routes, transportation service provider information, and scheduling information, wherein each trip comprises a trip departure date and a trip delivery date;
means for selecting a trip from the set of trips based on a set of criteria; and
means for scheduling the trip such that the good is scheduled to be delivered from the source location to the destination location substantially close to the requested delivery date.

25. A method for planning a delivery of at least one good, comprising:
receiving sales order information, the sales order information including a description of the good, a destination location, and an indication of when delivery of the good is requested;
selecting a source location for the good based on whether the good is available at the source location;
determining a set of trips based on a set-of geographic routes, transportation service provider information, and an availability date of the good at the source location;
selecting a trip from the set of trips based on a set of criteria; and
scheduling the trip based on the availability date, such that the good is scheduled to be delivered from the source location to the destination location.

26. The method of claim 25 further comprising:
eliminating trips based on dangerous good data.

27. The method of claim 25, further comprising:
receiving, as the indication, an instruction to delivery the good as a rush order.

28. The method of claim 27, wherein scheduling further comprises:
scheduling forward from the availability date, when the indication corresponds to the rush order.

29. The method of claim 25, further comprising:
updating sales order information with one or more dates corresponding to the scheduled trip.

30. A method for planning a delivery of at least one good, comprising:
receiving sales order information, the sales order information including a description of the good, a destination location, and a requested delivery date;
selecting a source location for the good based on whether the good is available at the source location;
determining a set of trips based on a set of geographic routes, transportation service provider information, and the requested delivery date;
selecting a trip from the set of trips based on a set of criteria; and
scheduling back from the requested delivery date, such that the good is scheduled to be delivered from the source location to the destination location substantially close to the requested delivery date.
